(19) United States
(12) Patent Application Publication
(10) Pub. No.: US 2018/0317473 A1
(43) Pub. Date: Nov. 8, 2018

(54) SYSTEMS AND METHODS FOR ATTRACTING INSECTS BY SIMULATING WING FLASH

(71) Applicant: Gerhard J. GRIES, Coquitlam (CA)

(72) Inventors: Gerhard J. Gries, Coquitlam, BC (CA); Michael George Hrabar, North Vancouver, BC (CA); Lydia Carrol Stepanovic, Thunder Bay, ON (CA); Courtney Elaine Eichorn, Langley, BC (CA); Emma Christina Van Ryn, Burnaby, BC (CA); Bekka Sue Brodie, Athens, OH (US); Adam James Blake, Burnaby, BC (CA); Roohy Thandi, Surrey, BC (CA)

(21) Appl. No.: 15/773,985

(22) PCT Filed: Nov. 4, 2016
(86) PCT No.: PCT/US16/60708

§ 371 Date: May 4, 2018

Related U.S. Application Data
(60) Provisional application No. 62/252,223, filed on Nov. 6, 2015.

(51) Int. Cl. A01M 1/04; A01M 1/10

(52) U.S. Cl. CPC A01M 1/04; A01M 1/023; A01M 1/106

(57) ABSTRACT

Systems and methods for attracting insects by simulating wing flash are disclosed. In one embodiment, a method for attracting insects by simulating wing flash can include (1) determining a light-pulse frequency that mimics a wing flash for a target winged insect species; and (2) controlling a light source to emit light at the light-pulse frequency. Devices for attracting insects by simulating wing flash are also disclosed.

### REFERENCE TO RELATED APPLICATIONS

The present application claims the priority of U.S. provisional application Ser. No. 62/252,223, entitled SYSTEMS AND METHODS FOR ATTRACTING INSECTS BY SIMULATING WING FLASH, filed Nov. 6, 2015, and hereby incorporates the same application herein by reference in its entirety.

### TECHNICAL FIELD

The present disclosure generally relates to systems and methods for attracting insects by simulating wing flash.

### BACKGROUND

Insects, such as those in the order Diptera (e.g., the house fly), are not only a nuisance to people and animals, but they also cause hygiene and health issues. Because of this, a considerable amount of effort is spent in controlling these pests. Due to its high reproductive rate, however, the house fly has developed resistance to commonly used pesticides. Other control methods, such as window traps and light traps, have also been ineffective at reducing house fly populations to acceptable levels.

### SUMMARY

According to one embodiment, a device for attracting insects by simulating wing flash includes a light source, and a controller that controls the operation of the light source. The light source emits light at a light-pulse frequency that mimics a wing flash for a target winged insect species.

According to another embodiment, a method for attracting insects by simulating wing flash includes controlling a light source to emit light at a light-pulse frequency that mimics a wing flash for a target winged insect species.

In accordance with another embodiment, a method for attracting insects by simulating wing flash includes determining a light-pulse frequency that mimics a wing flash for a target winged insect species, and controlling a light source to emit light at the light-pulse frequency.

### BRIEF DESCRIPTION OF THE DRAWINGS

FIG. 1 depicts a system for attracting insects by simulating wing flash according to one embodiment.

FIG. 2 depicts a method of determining a light-pulse frequency at which insects are attracted according to one embodiment.

FIG. 3 depicts a method of determining a light-pulse frequency at which insects are attracted according to another embodiment.

FIG. 4 depicts an example of a method for attracting Lucilia sericata insects by simulating wing flash according to one embodiment.

FIGS. 5A to C depict schematic drawings of experimental apparatuses for examining the behavior of flies to pulsed light that mimics the wing flash frequency of flying females of the same species according to certain embodiments.

FIGS. 6A to G depict the results of experiments demonstrating the preference of Lucilia sericata males and females to pulsed light that mimics the wing flash frequency of flying females or males of the same species.

FIG. 7 depicts the preference by Musca domestica males for pulsed light emitted at a frequency (160 Hz) characteristic of the wingbeat frequency of flying females of the same species.

FIG. 8 depicts the preference by Hermetia illicens males for light pulsed at a frequency (100 Hz) characteristic of the wingbeat frequency of flying females of the same species.

FIG. 9 depicts the preference by Drosophila melanogaster females for light pulsed at a frequency of 8 Hz for 1 sec, then 0 Hz for 3 sec, characteristic of the wing flash frequencies of stationary males lekking on a food substrate.

FIG. 10 depicts the optimal preference by Aedes aegypti males for light pulsed from clustered LEDs at a frequency of 665 Hz that mimics the frequency of light reflections off the wings of swarming flying females.

FIG. 11 depicts the preference by Aedes aegypti males for blue light pulsed from clustered LEDs at a frequency of 665 Hz over white light pulsed from clustered LEDs at a frequency of 665 Hz.

FIG. 12 depicts the preference by Aedes aegypti males for oscillating over stationary clusters of LEDs pulsing light at a frequency of 665 Hz that mimics the frequency of light reflections off the wings of swarming flying females.

### DETAILED DESCRIPTION

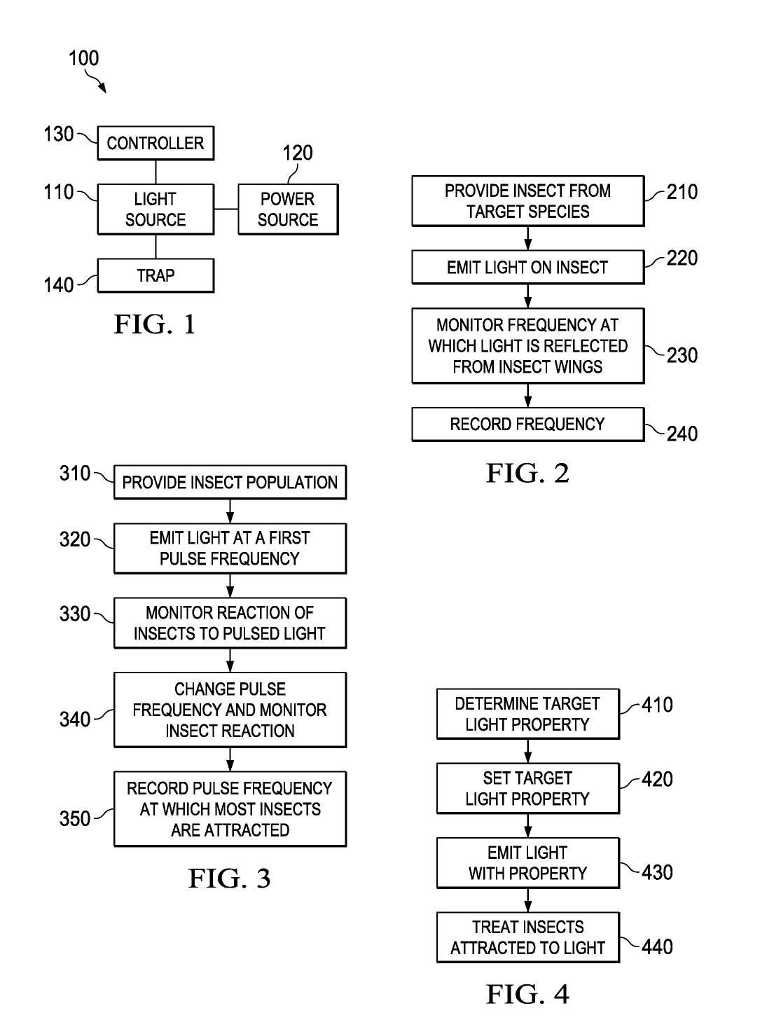

Referring to FIG. 1, a system for attracting insects by simulating wing flash according to certain embodiments is disclosed. System 100 can include light source 110, power source 120, controller 130, and trap 140.

In certain embodiments, light source 110 can be any suitable light source that is capable of pulsing light and/or energy at a frequency that mimics the reflection of light off a flying insect's wings. This can be referred to herein as the “wing flash” from an insect. In certain embodiments, light source 110 can be a light emitting diode (“LED”). In certain embodiments, light source 110 can also, or alternatively, be an incandescent lamp, a Xenon lamp, a mercury-xenon lamp, a deuterium lamp, a laser diode, another light emitting device, etc.

In certain embodiments, light source 110 can emit light at a single wavelength. In certain embodiments, light source 110 can alternatively emit light at multiple wavelengths or over a range of wavelengths such as, for example, white light. In certain embodiments, light source 110 can emit light with a wavelength that mimics the wavelength of a wing flash of a target insect.

In certain embodiments, light source 110 can be sized and/or shaped to approximate the size and/or shape of a wing of the target insect. In certain embodiments, light source 110 can emit light of a size and/or shape that approximates the size and/or shape of a wing of the target insect.

In certain embodiments, more than one light source 110 can be provided. As can be appreciated, a single light source 110, or grouped light sources 110, can also emit light from multiple positions. In certain embodiments, the positions of the light sources 110 can change over time individually or collectively. For example, a light source 110 can include one or more individually controlled LEDs in certain embodiments that can be stationary or oscillating. As can be appreciated, more complex movement patterns for the light source(s) 110 can also be provided.

In certain embodiments, light source 110 can be powered by power source 120. Any suitable power source can be suitable, including batteries, solar power, AC power, DC power, etc.

Light source 110 can be controlled by controller 130, which can include an application-specific integrated circuit (ASIC). In certain embodiments, controller 130 can be a microprocessor-based controller. In certain embodiments, controller 130 can include a hardware circuit.

In certain embodiments, controller 130 can include an interface (not shown). In certain embodiments, the interface can be a wireless (e.g., RF, IR, WiFi, etc.) interface. In certain embodiments, the interface can further, or alternatively, include one or more knobs, switches, etc. for selecting a light-pulse frequency or any other operating characteristic.

The system 100 can optionally further include trap 140 in certain embodiments. The trap 140 can be used to capture and/or dispose of insects. In certain embodiments for example, trap 140 can be a physical trap from which insects have difficulty escaping. In certain embodiments, trap 140 can also, or alternatively, include a physical retention mechanism, such as an adhesive. In certain embodiments, trap 140 can also, or alternatively, include a lethal composition. For example, in certain embodiments, trap 140 can include one or more chemicals, pathogens, or sources of electricity to kill an insect.

As previously noted, the light source 110 can emit light in a manner that mimics the wing flash of an insect. As will be appreciated, it has been found that Calliphoridae (commonly known as blow flies, carrion flies, bluebottles, greenbottles, cluster flies, or screwworms) beat their wings at different frequencies depending on species, age, gender, and/or reproductive status. For example, young, sexually mature females can have a different wing flash frequency than older females, young males, and older males.

In certain embodiments, light source 110 can emit light at a light-pulse frequency ranging between about 1 pulse per second and about 1,000 pulses per second. In certain embodiments, light source can emit light at a light-pulse frequency ranging from about 20 pulses per second and about 750 pulses per second. In certain embodiments, the light can be emitted at a light-pulse frequency ranging between about 50 pulses per second and about 200 pulses per second. In certain embodiments, the light can be emitted at a light-pulse frequency ranging between about 175 pulses per second and about 195 pulses per second.

In certain embodiments, the light can be emitted at a light-pulse frequency ranging between about 400 pulses per second and about 800 pulses per second. In certain embodiments, the light can be emitted at a light-pulse frequency ranging between about 500 pulses per second and about 700 pulses per second. In certain embodiments, the light can be emitted at a light-pulse frequency of about 600 pulses per second and about 700 pulses per second. In certain embodiments, the light can be emitted at a light-pulse frequency of about 190 pulses per second. In certain embodiments, the light can be emitted at a light-pulse frequency of about 665 pulses per second.

As will be described herein, the light-pulse frequency can vary depending on the species of a target insect. For example, the light-pulse frequency of Aedes Aegypti females can be about 665 pulses per second while the light-pulse frequency of Lucila sericata females can be about 190 pulses per second.

In certain embodiments, light source 110 can output light pulses at one or more frequencies. In certain embodiment, light source 110 can also, or alternatively, output light at one or more wavelengths.

As can be appreciated, other sensors and devices, such as a light sensor (not shown), a clock/timer (not shown), memory (not shown), etc. can be provided as is necessary and/or desired. For example, in certain embodiments, system 100 can be set to operate to attract one type of insect at a first portion of the day, and another type of insect at a second or third portion of the day (e.g., light source 110 can emit light and/or energy at a first light-pulse frequency during the morning, a second light-pulse frequency during the afternoon, and a third light-pulse frequency during the evening). In certain embodiments, controller 130 can select a light-pulse frequency based on the intensity of light sensed by a light sensor. In other embodiments, controller 130 can select a light intensity (e.g., brightness) of pulsed light based on the intensity of ambient light sensed by the light sensor.

As can be appreciated, many variations are possible. For example, the controller 130 can control system 100 to emit light in more complex patterns in certain embodiments. For example, controller 130 can control additional light sources 110, control physical movement of the light sources 110, or direct light source 110 to emit light in a short sequence of different frequencies or wavelengths in certain embodiments.

Referring to FIG. 2, a method of determining at least one characteristic of light that mimics the wing flash of an insect according to certain embodiments is disclosed. In step 210, an insect species from a target group of insect species can be identified. In certain embodiments, the insect can be a young, sexually mature female. In certain embodiments, the insect can be secured as described, for example, in the described examples below. In other certain embodiments, one or more insects can be free to fly within a confined area, such as a cage.

In step 220, light can be projected onto the insect. In certain embodiments, the light can be constantly projected (e.g., light having no pulses).

In step 230, the frequency at which the light is reflected from the wings can be monitored using, for example, a camera, a photosensor, etc.

In step 240, the frequency can be recorded.

As can be appreciated, the process can be repeated for multiple insects, and the frequency can then be selected using statistical analysis to determine the most common, or more responsive, frequency. For example, the process can be repeated for insects of the same gender, insects of the other gender, insect ages, insects raised in different climates, insects raised on different diets, and for insects that differ in their degree of sexual maturity.

Referring to FIG. 3, a method of determining at least one characteristic of light that mimics the wing flash of an insect according to certain embodiments is disclosed. In step 310 a plurality of insects can be provided.

In step 320, light can be emitted at a light-pulse frequency from a light source.

In step 330, the reaction of the plurality of insects can be monitored to determine whether the insects are attracted to the light-pulse frequency.

In step 340, the light-pulse frequency can be changed, and the process repeated.

In step 350, the light-pulse frequency at which most insects are attracted can be recorded.

In certain embodiments, rather than projecting light on an insect and optically monitoring the reflection from the insect's wings, the sound produced by an insect's moving wings can be recorded and analyzed to determine the wingbeat frequency. In certain embodiment, a Fourier transform can be run based on the observed sound over a time period to determine the dominant wingbeat frequency.

Referring to FIG. 4, a method for attracting insects by simulating wing flash according to certain embodiments is disclosed.

In step 410, the target light property for a particular species is determined. For example, the light-pulse frequency for the target insect can be determined. Other properties, such as wavelength, spectrometric profile of wavelengths, brightness, intensity, duty cycle, number of lights, physical movement, etc. can also be determined as is necessary and/or desired.

In step 420, one or more lights can be controlled to match the target light property. For example, in certain embodiments, the light source can be controlled to emit light at the target light-pulse frequency. In certain embodiments, multiple lights can be used to match the target light property of a target insect.

In step 430, the one or more lights can emit light with the target light property.

In step 440, the insects attracted to the light can be captured, killed, exposed to a lethal composition, or otherwise treated as is necessary and/or desired.

In certain embodiments, the light-pulse frequency can cycle. For example, in certain embodiments, the light can be emitted at a first light-pulse frequency, and can periodically change to a second light-pulse frequency. In certain embodiments, the second light-pulse frequency can also be the absence of light or constant light.

In certain embodiments, the light-pulse frequency can change based on environmental considerations, such as time of day, time of year, temperature, humidity, geographic location, etc.

In certain embodiments, the light-pulse frequency can be adjusted, or fine-tuned, to optimally attract target insects.

Although embodiments have been disclosed in the context of attracting a target insect, it should be noted that these embodiments can be used to repel target insects as well by emitting light at a light-pulse frequency that repels the target insects.

### EXAMPLES

The following examples and experiments are illustrative of methods for determining at least one characteristic of light that mimics the wing flash of an insect. These examples are illustrative only and do not limit the disclosure.

### Example 1: Rearing of Experimental Insects

Greenbottle flies, Lucilia sericata, were reared in the insectary at Simon Fraser University, starting a new colony with field-collected wild flies every 12 months. Flies were cold-sedated within 24 hours following eclosion, separated by sex, and kept in groups of 50 males or 50 females in separate wire mesh cages (44×44×44 cm; BioQuip®, Compton, Calif., USA) under a L16:D8 photoperiod, 30% to 40% relative humidity, and a temperature of 23° C. to 25° C. Flies were provisioned with water, milk powder, sugar and liver ad libitum and were bioassayed when they were 1 to 7 days old.

House flies, Musca domestica, were reared in the insectary at Simon Fraser University. Flies were cold-sedated within 24 hours following eclosion, separated by sex, and kept in groups of 50 in separate wire mesh cages (44×44×44 cm; BioQuip®, Compton, Calif., USA) under a L16:D8 photoperiod, approximately 30% relative humidity, and a temperature of 23° C. to 25° C. Flies were provisioned with water, milk powder, and sugar. Bioassays were performed with 3- to 5-day-old male flies.

Late instar larvae of the black soldier fly, Hermetia illucens, were purchased from Recorp Inc. and reared in the insectary at Simon Fraser University. Within 24 hours of eclosion, flies were separated by sex via by examination of genitalia. Males were kept in groups of 10 in separate acrylic cages (30×15×10 cm) under a L16:D8 photoperiod, approximately 30% relative humidity, and a temperature of 23° C. to 25° C. Adult flies do not feed and thus were provisioned with water only. Bioassays were performed with 2- to 3-day-old male flies.

Common vinegar or fruit flies, Drosophila melanogaster, were reared in the insectary at Simon Fraser University. The sex of eclosed flies was determined within 24 hours by examination of the genitalia of cold-sedated flies. Females were kept in groups of 50 in separate acrylic cages (30×15×10 cm) under a L16:D8 photoperiod, approximately 30% relative humidity, and a temperature of 23° C. to 25° C. Flies were provisioned with standard Drosophila media (yeast, agar, cornmeal and molasses). Bioassays were performed with 1- to 4-day-old female flies.

Yellow fever mosquitoes, Aedes aegypti, were reared in the insectary at Simon Fraser University. Flies were cold-sedated within 24 hours following eclosion, and their sex determined by examination of antennal morphology. Males were kept in groups of 50 in separate wire mesh cages (44×44×44 cm; BioQuip®, Compton, Calif., USA) under a L16:D8 photoperiod, approximately 30% relative humidity, and a temperature of 23° C. to 25° C. Flies were provisioned with a 10% sugar water solution. Bioassays were performed with 2- to 7-day-old male mosquitoes.

### Example 2: Responses by Lucilia sericata Males to Mounted Females, One Able to Wing-Fan, the Other with Wings Glued

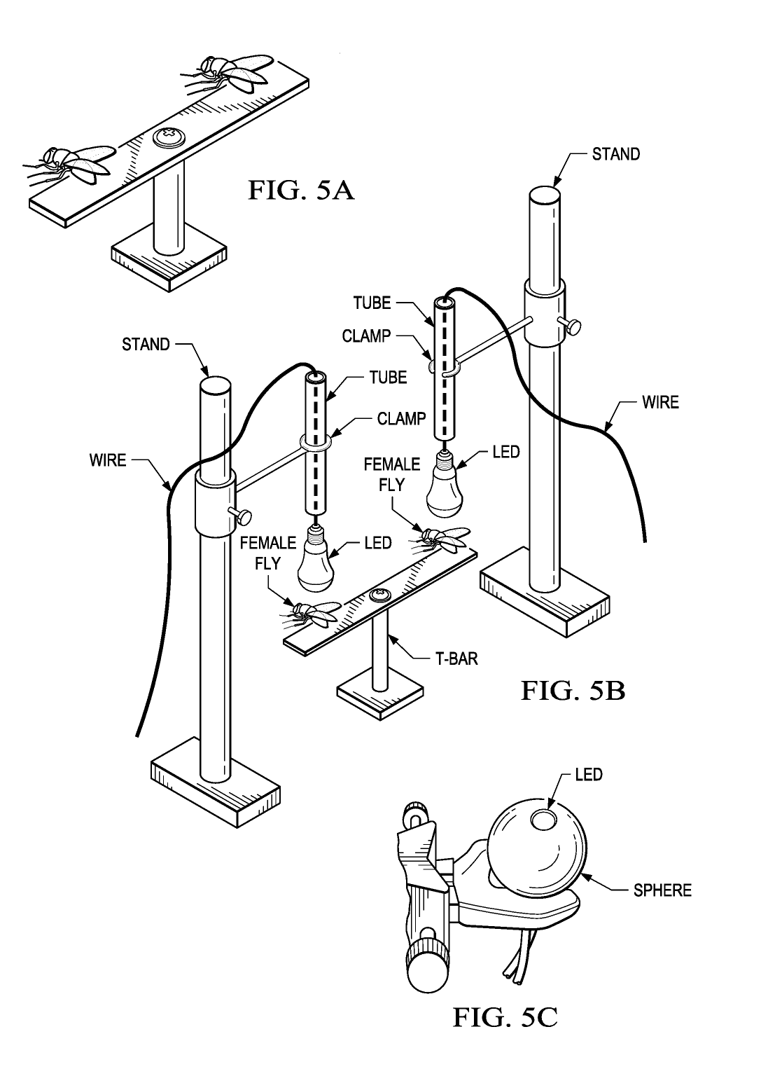

For each replicate (N=10) of Experiment 1, two live Lucilia sericata females were CO₂-sedated for 30 sec, and then mounted with super glue (Gorilla Glue®, Cincinnati, Ohio, USA) on their abdominal ventrum, 7 cm apart from one another on an aluminum T-bar (FIG. 5A). A small amount of super glue was also applied to the wing base of one randomly assigned female, thus immobilizing her wings. The same amount of super glue was applied to the abdomen of the other female, leaving her wings free to move.

The T-bar with the two females was then introduced into a wire mesh bioassay cage (44×44×44 cm; BioQuip®, Compton, Calif., USA) containing 50 Lucilia sericata males. The cage was illuminated from above with a full spectrum light source (two horizontal mercury lamps: Philips, plant & aquarium (40 W); Sylvania, Daylight Deluxe (40 W)). To minimize light reflections, the metal cage floor and T-bar stand were covered with SunWorks® black construction paper (Pacon Corporation, Appleton, Wis., USA) and black velvet (Dressew supply, Vancouver, BC, Canada), respectively. During each 40-min bioassay, the number of alighting responses by males on a female, or near a female followed by physical contact with her, was recorded. The mean numbers of alighting responses by males on females with wings immobilized or free were analyzed by a t-test.

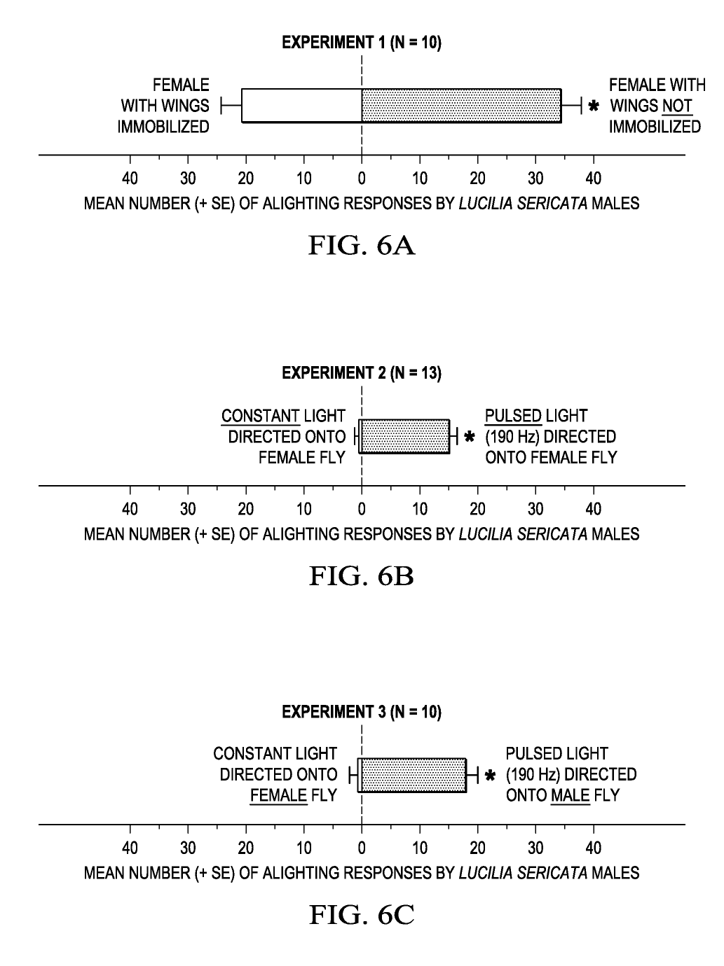

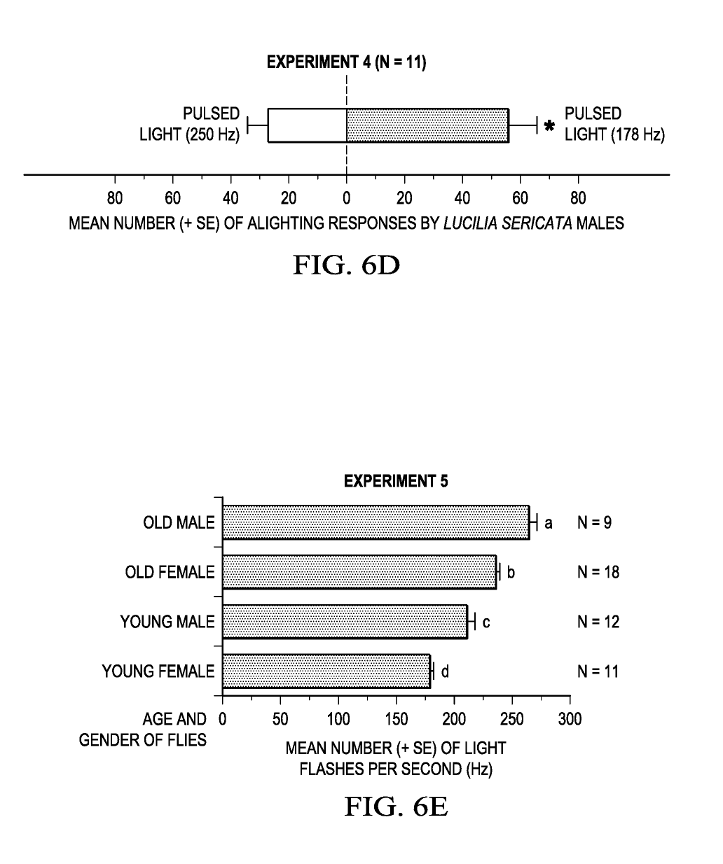

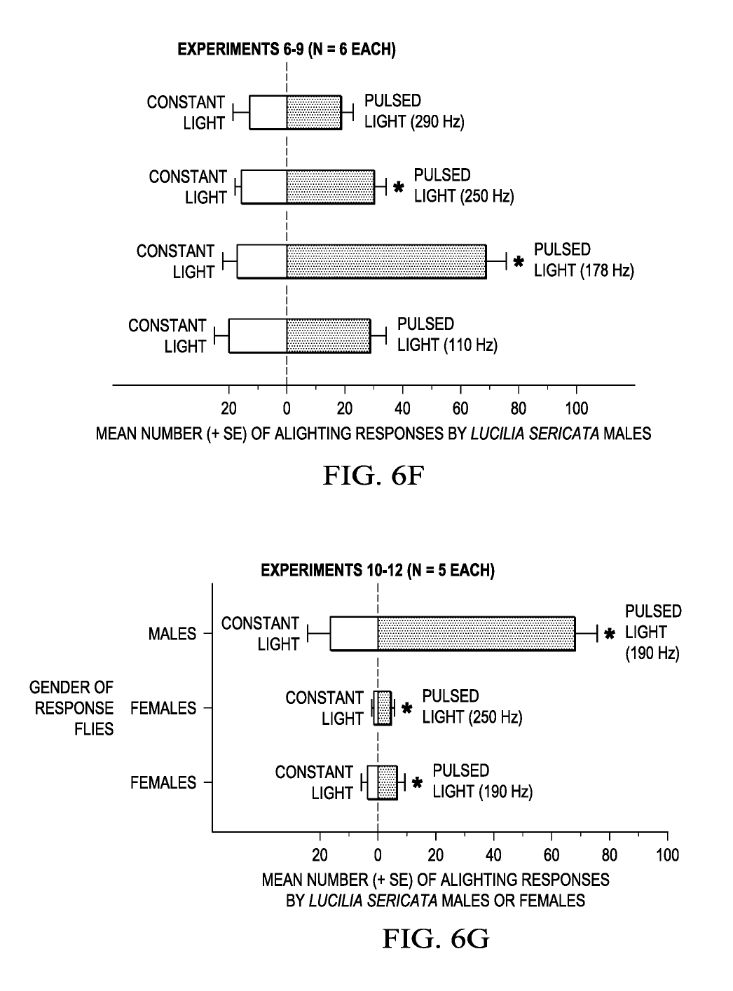

There were significantly more alighting responses (mean±SE) by Lucilia sericata males on or near females that could move their wings than on females that could not (34.1±3.76 versus 20.6±3.79, t=2.5306, P=0.0209. The results are depicted in FIG. 6A.

These results reveal that wing movement by Lucilia sericata females is an important mate recognition cue for males.

### Example 3: Responses by Male Flies to Paired Tethered Females, Both with their Wings Glued but One with Pulsed Light Reflecting Off her Wings

For each replicate (N=13) of Experiment 2, two live Lucilia sericata females were mounted on an aluminum T-bar as depicted in FIG. 5A and as described above. The wings of each female were immobilized with super glue and thus could not move. One randomly assigned female was illuminated from above by an LED (Optek Technology Inc., Carrollton, Tex. 75006, USA) that was mounted 3 cm above the female as depicted in FIG. 5B and that produced 5-Volt, white-light pulses at a frequency of 190 Hz and a duty cycle of 3%. The pulse frequency of 190 Hz was approximately mid-way between the light-flash frequencies of flying two-day-old female and male flies. The other female was illuminated by a second LED of the same type that produced constant light at the same light intensity as depicted in FIG. 5B. For each replicate, the T-bar with the two females was placed into a wire mesh bioassay cage containing 50 male flies. During 40 min in each replicate, the numbers of alighting responses by these 50 male flies on either female were recorded. The mean numbers of alighting responses on either female were analyzed by a t-test.

Lucilia sericata females illuminated by pulsed light received significantly more alighting responses by males (mean±SE) than did females illuminated by constant light (14.0±1.8 versus 0.23±0.12; t=8.09, P<0.0001). The results are depicted in FIG. 6B.

These results support the conclusion that pulsed light projected onto, and reflecting off, immobilized female wings, rather than the movement of wings, is attractive to Lucilia sericata males.

### Example 4: Response by Lucilia sericata Males to Paired Male and Female Flies, Both with their Wings Immobilized, and Pulsed Light Reflecting Off the Male's Wings

Experiment 3 (N=10) was designed to determine whether or not the attractiveness of pulsed light reflected off female wings is dependent upon specific physical properties of female wings. In each replicate, one live female fly and one live male fly were mounted 7 cm apart from one another on an aluminum T-bar, as described above and illustrated in FIG. 5A. The wings of each fly were immobilized with super glue. The male was illuminated from above by an LED, as illustrated in FIG. 5B, that produced 5-Volt, white-light pulses at a frequency of 190 Hz and a duty cycle of 3%. The female was illuminated by a second LED of the same type that produced constant light at the same light intensity. During 40 min in each replicate, the number of alighting responses by 50 males on the mounted male fly or female fly was recorded. The mean numbers of alighting responses by males on the male or female were analyzed by a t-test.

Immobilized males exposed to pulsed light (190 Hz) received significantly more alighting responses by Lucilia sericata males (mean±SE) than did females illuminated by constant light (18.1±2.97 versus 0.8±0.29; t=5.54, P<0.0001). The results are depicted in FIG. 6C.

These results indicate that the preference by Lucilia sericata males for pulsed light reflected off wings is not dependent upon specific physical properties of female wings.

### Example 5: Response by Lucilia sericata Males to Light Pulsed from LEDs

Experiment 4 (N=11) was designed to determine whether or not the attractiveness of pulsed light is dependent upon its reflection off fly wings. To that end, the two mounted flies used in previous Examples 2 to 4 were replaced with two shiny-black acrylic spheres as depicted in FIG. 5C (1.77 cm diameter; supplier unknown) that were mounted on clamps 12 cm apart from one another and 12 cm above the floor of the bioassay cage containing 50 male flies. A central hole (0.52 cm) in each sphere accommodated an upward pointing LED, the rounded lens of which was sanded down to be flush with the sphere's surface. Sanding the lens ensured that the emitted light was visible to flies from many viewing angles rather than from just the narrow viewing angle that the lens otherwise creates.

By random assignment, one LED produced 5-Volt, white-light pulses at a frequency of 178 Hz, which is the mean number of light flashes reflected per second off the wings of flying two-day-old females. The second LED produced the same type of light pulses at a frequency of 250 Hz, which is mid-way between the mean number of light flashes reflected per sec off the wings of flying seven-day-old females and males. These two light pulse frequencies were chosen to determine whether males not only respond to light pulsed from LEDs in the absence of flies but also to distinguish between flash frequencies that are indicative (178 Hz), or not (250 Hz), of young flying females as prospective mates. The mean numbers of alighting responses by males on the two spheres accommodating LEDs with a flash frequency of either 178 Hz or 250 Hz were analyzed by a t-test.

Black acrylic spheres holding an LED that emitted light pulses at a frequency of 178 Hz received significantly more alighting responses by Lucilia sericata males (mean±SE) than spheres holding an LED that emitted light pulses at a frequency of 250 Hz (55.9±9.24 versus 26.7±6.31; t=2.23, P<0.006). The results are depicted in FIG. 6D.

These results indicate unexpectedly that Lucilia sericata males respond to light pulsed by LEDs in the absence of flies, and that males prefer the light-pulse frequency indicative of wing flashes from young females that are prospective mates over the light-pulse frequency indicative of wing flashes from old males and females that are unfavorable mates.

### Example 6: Analyses of Differences in Light Flash Frequencies Associated with Age and Gender of Flying Lucilia sericata

The objective of Experiment 5 was to determine whether the numbers of light flashes reflected off the wings of free-flying individuals differ in accordance with the age or gender of flies. To this end, two-day-old (young) and seven-day-old (old) Lucilia sericata males and females were filmed in free flight using a Phantom Miro 3 high-speed camera (Vision Research, Wayne, N.J. 07470, USA) at a rate of 15,325 frames per sec and a 34-μsec exposure time imaged through a Canon 100-mm f2.8L macro lens (Canon Canada Inc., Vancouver, BC V6C-3J1, Canada) fitted to a 36-mm extension tube. For each recording event, 50 young or 50 old male or female flies were placed into a wire mesh cage (61×61×61 cm) housing a 100 Watt (approximately 9000 Lumen), cool-white (5000-6000 Kelvin) LED, which was driven by a 32-volt switching-power supply (model CPS-3010, Gopher Technologies, Yantian, Fenggang Town, Dongguan, Guangdong, China). Once the camera and light were turned on, the cage was lightly tapped to induce take-off and flight by flies that were resting on the cage walls and floor.

In video-recorded data files, the number of light flashes reflected within one sec off the wings of free-flying young females (N=11), young males (N=12), old females (N=18), and old males (N=9) were counted. Light-flash frequencies of young and old females and of young and old males were subjected to an analysis of variance followed by the Tukey test for comparisons of means.

The results of this experiment reveal that there are significant differences in the number of light flashes reflected off the wings of free-flying young and old females and young and old males (F=96.22, P<0.001). Young females had a mean (±SE) flash frequency of 178.72 Hz (±2.86 Hz), which was significantly lower than that of young males (212.0±4.18 Hz), old females (235.08±2.58 Hz), and old males (266±4.53 Hz). The results are depicted in FIG. 6E.

The two-day-old females were two to four days younger than the age preferred by males, but were tested because they were the only flies available at the same time as the camera. By 4 to 6 days of age, females have had a chance to feed and develop their ovaries. Their abdomens become larger, and the additional weight would demand a higher wing beat frequency to achieve efficient flight. Therefore, the optimal wing flash frequency to attract Lucilia sericata males is probably closer to the 190 Hz frequency tested in Experiments 2, 3, and 10, rather than to the 178 Hz frequency tested in Experiments 4 and 8. This conclusion is supported by the very strong responses to pulsed light when test flies were given a choice between constant light and pulsed light at 190 Hz.

Because Lucilia sericata males seek young females as prospective mates, the slower wing flash frequency of young females than of males or older individuals of either sex appears to signal the most receptive reproductively-capable females.

### Example 7: Ability of Lucilia sericata Males to Discriminate Between Light Pulsed at Varying Frequencies

To determine whether mate-seeking males can distinguish between different frequencies of pulsed light, parallel-run Experiments 6 to 9 (N=6 each) tested alighting responses by males on paired black acrylic spheres as depicted in FIG. 5C. Each sphere included a white-light LED. By random assignment, one LED in each pair emitted constant light, whereas the other emitted light pulses at a frequency of 290 Hz (Experiment 6), 250 Hz (Experiment 7), 178 Hz (Experiment 8), or 110 Hz (Experiment 9). The frequencies of 290 Hz and 110 Hz were selected to test the response of males to pulse frequencies that are well above or below the wing flash frequencies produced by flying greenbottle flies. In each of Experiments 6 to 9, the mean numbers of alighting responses by males on paired spheres holding LEDs emitting constant light or pulsing light were analyzed by a t-test.

Males in Experiments 6 and 9 did not respond to pulsed light at 290 Hz or 110 Hz, respectively, in significantly greater numbers than to constant light as depicted in FIG. 6F (Experiment 6: mean±SE: 18.8±4.0 versus 13.7±5.7; t=1.39, P=0.22; Experiment 9: 30.0±6.02 versus 20.5±4.5; t=1.42, P=0.21). In Experiment 7, spheres with an LED emitting light pulsing at 250 Hz received twice as many alighting responses by males than did the spheres with an LED emitting constant light as depicted in FIG. 6F (mean±SE: 34.6±4.8 versus 17.0±1.6; t=3.52, P=0.01). In Experiment 8, spheres with an LED emitting light pulsed at 178 Hz received 4.2 times more alighting responses by males than did the paired spheres with an LED emitting constant light as depicted in FIG. 6F (mean±SE: 72.2±12.9 versus 17.2±5.2; t=4.79, P=0.004).

The results of Experiments 6 to 9 reveal that Lucilia sericata males do not simply prefer pulsed light to constant light. Rather, Lucilia sericata males most strongly prefer pulsed light only if it occurs at frequencies within the range of wing flashes from young Lucilia sericata females.

### Example 8: Comparative Preferences of Lucilia sericata Males and Females to Pulsed Over Constant Light

Experiments 10 to 12 (N=5 each) compared the response of males to pulsed (190 Hz) light over constant light (Experiment 10) with that of females to pulsed light at 250 Hz (Experiment 11) or 190 Hz (Experiment 12). The bioassay protocol for each replicate of each experiment was as described under Example 4, above.

In each of Experiments 10 to 12, the mean numbers of alighting responses by males (Experiment 10), or by females (Experiments 11 and 12), on spheres holding LEDs emitting pulsed light or constant light were analyzed by a t-test. In Experiment 10, spheres holding LEDs emitting pulsed light at 190 Hz (indicative of flying receptive females) received 4.1 times more alighting responses by males as depicted in FIG. 6G than spheres holding LEDs emitting constant light ((mean±SE: 68.6±8.1 versus 16.6±7.6; t=11.37, P=0.0003).

In Experiment 12, spheres holding LEDs emitting pulsed light at 250 Hz (midway between the frequencies emitted by flying old females and males) received 3.1 times more alighting responses by Lucilia sericata females (mean±SE) than spheres holding LEDs emitting constant light (4.66±0.9 versus 1.5±0.6; t=5.83, P=0.002). In Experiment 12, spheres holding LEDs emitting pulsed light at 190 Hz received 1.8 times more alighting responses by females (mean±SE) than spheres emitting constant light (7.0±2.4 versus 3.8±1.8, t=2.99, P=0.04). The results are depicted in FIG. 6G.

The results of Experiment 11 confirm (see Examples 5 and 7) that Lucilia sericata males are strongly attracted to pulsed light at a frequency indicative of young flying females (prospective mates). The results of Experiments 12 and 13 reveal unexpectedly that Lucilia sericata females also respond more strongly to light pulsed at frequencies characteristic of con-specific individuals than to constant light. The results suggest that the response to pulsed light of particular frequencies exhibited by both males and females of Lucilia sericata can have practical utility in managing this and other pest species in the order Diptera.

### Example 9: Response by Musca domestica Males to Light Pulsed from LEDs

The objective of Experiment 13 (N=15) was to begin to determine if the wing flash attractiveness is a phenomenon isolated to Lucilia sericata or also occurs in other members of the order Diptera. The wingbeat frequency of house flies, Musca domestica, is reported in the literature as 160 Hz. Males of Musca domestica were given a choice between a white-light LED emitting constant light and a white-light LED emitting light pulsed at 160 Hz. LEDs were placed 15 cm apart at the bottom of a cage pointing upwards, and black fabric was placed under the LEDs to prevent reflection of light.

During each 20-min bioassay, the number of alighting responses by males on each LED was recorded. The mean proportions of alighting responses by males on LEDs emitting pulsed or constant light were analyzed by a t-test.

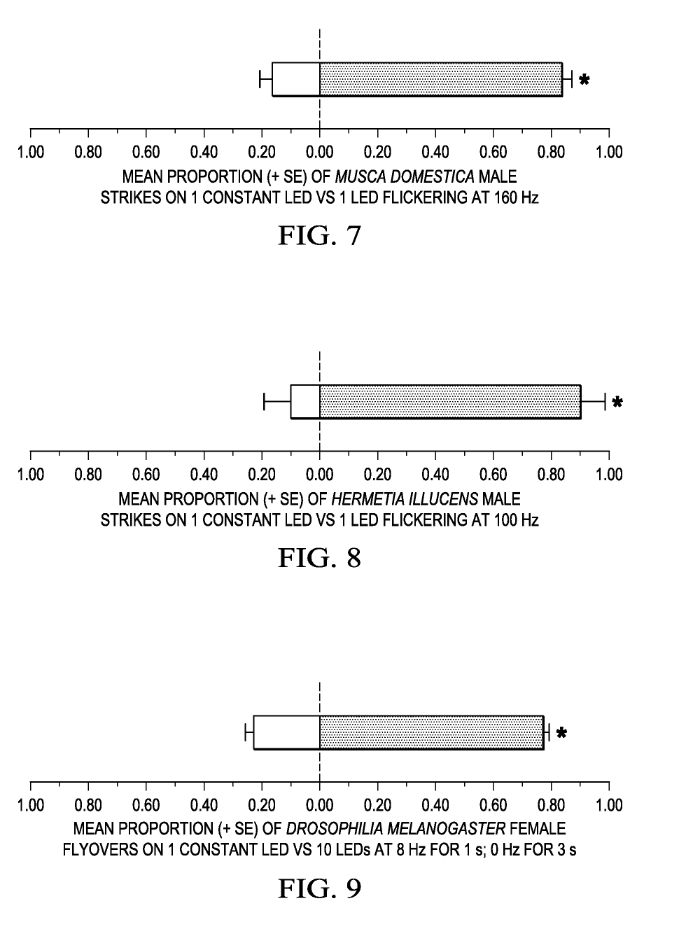

There was a significantly greater proportion of alighting responses (mean±SE) by Musca domestica males on LEDs emitting light pulsed at 160 Hz than on LEDs emitting constant light as illustrated by FIG. 7 (0.83±0.04 versus 0.17±0.04; t=2.05, P<0.0001).

These results indicate that like Lucilia sericata males, Musca domestica males also show a distinct preference for light flashing at frequencies equivalent to the wing beat frequencies of conspecific females. Of note is the fact that Lucilia sericata is in the family Calliphoridae, whereas Musca domestica is in the family Muscidae. Thus the results also suggest that the wing flash attraction phenomenon can extend to flies in additional families in the order Diptera.

### Example 10. Response by Hermetia illucens Males to Light Pulsed from LEDs

The objective of Experiment 14 (N=11) was to further determine if the wing flash attractiveness is a phenomenon isolated to Lucila sericata and Musca domestica or if it is more widespread in the order Diptera. The wing beat frequency of black soldier flies, Hermetia illucens, is reported in the literature as 100 Hz. Hermetia illucens males were given a choice between a white-light LED emitting constant light and a white-light LED emitting pulsed light at 100 Hz. The LEDs were placed 15 cm apart at the top of a cage pointing inwards, and black fabric was placed behind the LEDs to prevent reflection of light.

During each 10 min bioassay, the number of alighting responses by males on each LED was recorded. The mean proportions of alighting responses by males on LEDs emitting pulsed or constant light were analyzed by a t-test.

There was a significantly greater proportion of alighting responses (mean±SE) by Hermetia illucens males on LEDs emitting light pulsed at 100 Hz than on those emitting constant light as illustrated by FIG. 8 (0.9±0.09 versus 0.9±0.9, t=2.09, P<0.0001).

Hermetia illucens is in the family Stratiomyidae, the third family in the order Diptera in which males have been shown to have a distinct preference for light flashing at frequencies equivalent to the wing beat frequencies of conspecific females. This trend suggests that the wing flash attractiveness phenomenon is widespread in the order Diptera.

### Example 11. Response by Drosophila melanogaster Females to Pulsed Light from Clustered LEDs

The objective of Experiment 15 (N=13) was to determine if the wing flash attractiveness phenomenon can be extended to the wing-fanning courtship behavior of Drosophila species. Males of Drosophila melanogaster exhibit lekking behavior by resting at or on a food resource and fan their wings at specific frequencies and periodicities.

Wing-fanning by Drosophila melanogaster males was video-recorded in the laboratory, and the frequency and periodicity were determined as 1 sec at 8 Hz, and 3 sec at 0 Hz.

Preliminary experiments showed no response by females to single LEDs emitting pulsed or constant light. Therefore, Drosophila melanogaster females were given a choice between one white-light LED emitting constant light and 10 white-light LEDs randomly clustered within a 6.5-cm diameter circle. The clustered LEDs simulated a group of lekking males and emitted pulsed light pulsed at 8 Hz for 1 sec, then 0 Hz for 3 sec. Single and clustered LEDs were placed 15 cm apart at the bottom of a cage pointing upwards, and black fabric was placed behind the LEDs to prevent reflection of light.

During each 20-minute bioassay, the number of direct fly-over responses by females on each LED was recorded. This differed from other dipteran responses to flickering LEDs, as there were no landings or strikes on the clustered LEDs, but females were suddenly compelled to fly low and directly over them.

The mean proportions of these “fly-overs” by females on LEDs emitting constant or pulsed light were analyzed by a t-test. There was a significantly greater proportion of fly-overs (mean±SE) by females on LEDs emitting pulsed light than on the single LED emitting constant light as illustrated by FIG. 9 (0.77±0.025 versus 0.23±0.025, t=2.06, P<0.0001*).

The data of Experiment 15 further confirm that flies in the order Diptera respond to pulsed light that mimics the wing beat frequency of conspecific individuals. However, data for Drosophila melanogaster unexpectedly differ from those of other species in that the wing flashes originate from Drosophila melanogaster males that remain stationary on a substrate and flick their wings intermittently at a very low frequency. The results suggest that this same phenomenon will occur in dipteran species with lekking males.

### Example 12: Effect of Pulsed Light from LEDS on the Response Propensity of Aedes aegypti Males

The objective of Experiments 16 to 22 was to determine if the wing flash attractiveness is a phenomenon that extends to mating swarms of the yellow fever mosquito, Aedes aegypti, and to which wing beat frequency males most strongly respond. The wing beat frequency of Aedes aegypti is reported in the literature to vary from 400 Hz to 1000 Hz. The estimated optimal frequency, as determined by measuring the wing beat frequency of females during swarming flights, is 665 Hz.

A 16-channel pulse generator (5-Volt, 2-Amp) was designed and built by the Science Technical Centre at Simon Fraser University. Each channel allowed a single LED to have independent values set for amperage, duty cycle, frequency, and periodicity. Two ring stands were prepared with each containing a three dimensional arrangement of eight LEDs. The LEDs were arranged in a 15-cm assembly with seven LEDs encircling the eighth. These ring stands were placed 15-cm apart at the bottom of a cage with the LEDs pointing upwards. Black fabric was placed under the stands to prevent reflection of light.

Aedes Aegypti attraction was evaluated by pulsing the 16 LEDs at frequencies of: 430 Hz (N=15), 480 Hz (N=8), 500 Hz (N=8), 545 Hz (N=12), 665 Hz (N=16), 800 Hz (N=10), and 950 Hz (N=10). Aedes aegypti males were given a choice between a group of eight clustered white-light LEDs emitting constant light or a group of eight white-light LEDs emitting light pulsed at one of the above seven frequencies. The seven frequencies correspond to Experiments 16 to 22 respectively.

During each 20-min bioassay, the number of alighting responses by males on each LED was recorded. The mean proportions of alighting responses by males on LEDs emitting pulsed or constant light were analyzed by a t-test.

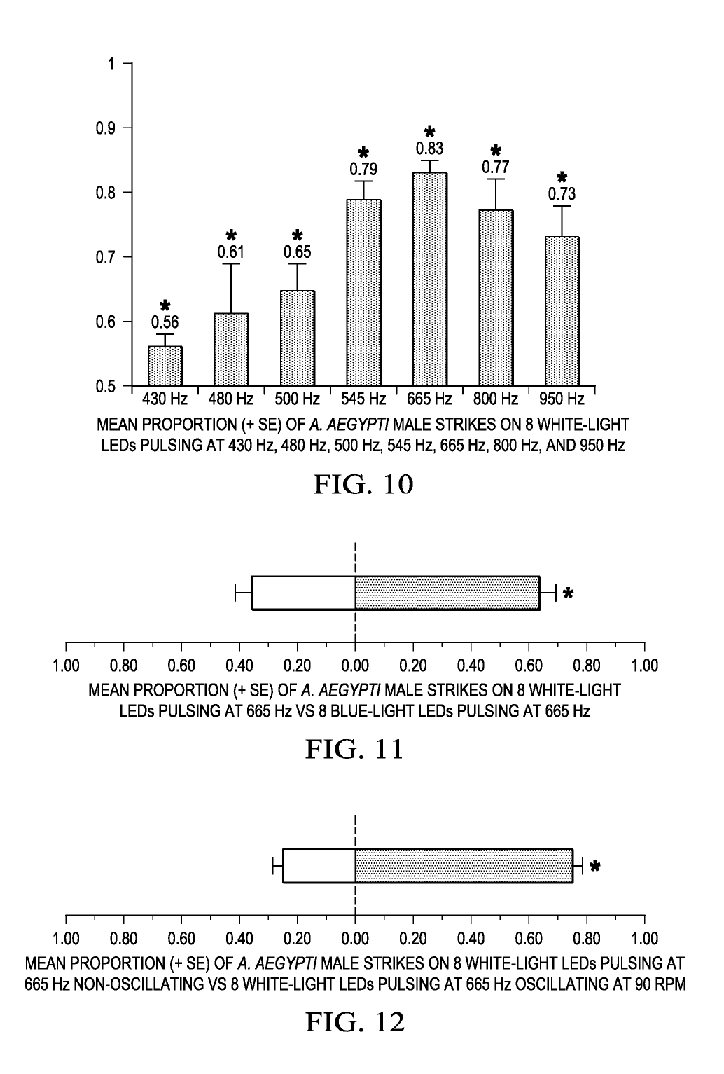

The optimal frequency of pulsed light was found to be 665 Hz, with proportions of strikes on LEDs pulsing light declining above and below the optimal frequency as depicted in FIG. 10. Mean response proportions±SE for each comparison of pulsed versus constant light were: 430 Hz (0.56±0.02 versus 0.44±0.02, t=2.05, P=0.0021*); 480 Hz (0.61±0.08 versus 0.39±0.08, t=2.14, P<0.0001*); 500 Hz (0.65±0.04 versus 0.35±0.04, t=2.14, P<0.0001*); 545 Hz (0.79±0.03 versus 0.21±0.03, t=2.07, P<0.0001*); 665 Hz (0.83±0.02 versus 0.17±0.02, t=2.04, P<0.0001*); 800 Hz (0.77±0.05 versus 0.23±0.05, t=2.10, P<0.0001*); 950 Hz (0.73±0.05 versus 0.27±0.05, t=2.10, P<0.0001*).

These results extend the wing flash attractiveness phenomenon to a fifth dipteran family, the Culicidae, strongly suggesting that the phenomenon can be expected to occur throughout the entire order. Once again, the behavior of A. Aegypti males is biologically meaningful, occurring in response to clustered LEDs that mimic the wing flash frequencies that would be expected to originate from a swarm of flying female mosquitoes.

### Example 13: Determination of Preference by Aedes aegypti Males for Pulsed Blue Light Over Pulsed White Light

The objective of Experiment 23 was to determine if the wing flash attractiveness is a phenomenon that occurs more intensely to a specific wavelength of light than to white light. The wings of Aedes aegypti reflect blue light. Thus, it was hypothesized that the response of Aedes aegypti males to LEDs emitting light between 450 and 495 nm would be greater than the response of Aedes aegypti males to LEDs emitting white light.

In Experiment 23 (N=10), Aedes aegypti males were given a choice as in Example 12 between eight clustered LEDs emitting white light pulsed at 665 Hz versus eight clustered LEDs emitting blue-light (450 nm to 495 nm) pulsed at 665 Hz.

During each 20-min bioassay, the number of alighting responses by males on each LED was recorded. The mean proportions of alighting responses by males on LEDs emitting white or blue light were analyzed by a t-test. There was a greater proportion of alighting responses (mean±SE) by males on LEDs emitting pulsed blue light than pulsed white light as illustrated by FIG. 11 (0.64±0.05 versus 0.36±0.05, t=2.10, P=0.0012*).

These results surprisingly indicate that Aedes aegypti males prefer blue light pulsed at 665 Hz to white light pulsed at 665 Hz. This preference corresponds to the color reflected off Aedes aegypti wings, and suggests that similar preferences would occur that correspond to the color reflectance from the wings of other dipteran species.

### Example 14: Determination of the Effect of Oscillating Versus Stationary Clusters of LEDs Emitting Pulsed Light on the Response of Aedes aegypti Males

The objective of Experiment 24 was to determine if the wing flash attractiveness by Aedes aegypti males can be intensified by oscillating movements of LED clusters. In nature, Aedes aegypti males encounter females in a swarm that moves in a swaying type pattern. Thus it was hypothesized that adding movement to LED clusters emitting light pulsed at the most attractive female wing beat frequency of 665 Hz (see Example 12) would enhance the responses of males.

In Experiment 24 (N=9), Aedes aegypti males were given a choice between eight white-light LEDs pulsing light at 665 Hz and eight white-light LEDs pulsing light at 665 Hz while oscillating at 90 RPM.

One hundred males were added to a large wood mesh cage (77×77×104 cm). Eight white-light LEDs pulsing light at 665 Hz were arranged in a 3-dimensional, 25-cm diameter assembly and placed on top of an oscillating shaker table (48×48 cm) (Barnstead Lab Line, MaxQ 2000) which moved at a speed of 90 RPM in a circular oscillating motion. In the same cage, 25 cm distant, eight white-light LEDs pulsing light at 665 Hz were arranged in a similar assembly and placed on a stationary plastic box of equal height as the oscillating shaker table. Both the oscillating shaker table and the plastic box were covered in black fabric to prevent light reflection.

During each 20-minute bioassay, the number of alighting responses by males on the LEDs in each of the two clusters was recorded. The mean proportions of alighting responses by males on oscillating and stationary LEDs were analyzed by a t-test.

There was a greater proportion of alighting responses (mean±SE) by males on oscillating LEDs than on stationary LEDs as illustrated by FIG. 12 (0.75±0.04 versus 0.25±0.04, t=2.12, P<0.001*).

These results further reinforce the importance of mimicking biological phenomena when designing an attractive light source for mosquitoes, and other dipterans as well. Surprisingly, oscillating clustered LEDs emitting light pulsed at the same frequency as female wing beats more precisely mimic a moving swarm of flying females mosquitoes than stationary clusters emitting light pulsed at the same frequency.

The following documents are hereby incorporated by reference in their entireties: Shields, E. J. Locomotory activity of Orius tristicolor under various intensities of flickering and non-flickering light. Annals of the Entomological Society of America 73: 74-77 (1980); Syms, P. R. and L. J. Goodman. The effect of flickering U-V light output on the attractiveness of an insect electrocutor trap to the house-fly, Musca domestica. Entomologica Experimentalis et Applicata 43: 81-85 (1987); Smallegange, R. D. Attractiveness of different light wavelengths, flicker frequencies and odours to the housefly (Musca domestica L.) (2003); PhD Thesis, University of Groningen, The Netherlands; Smallegange, R. D. Fatal attraction. Control of the housefly (Musca domestica). Entomologische Berichten 64(3): 87-92 (2004); Chu, C. C., T.-Y. Chen and T. J. Henneberry. Adult whiteflies (Homoptera: Aleyrodidae) and whitefly parasitoids (Hymenoptera: Aphelinidae) response to cool white fluorescent light powered by alternating or direct current. Southwestern Entomologist 29: 111-116 (2004); Chu, C. C., T.-Y. Chen and T. J. Henneberry. Attractiveness of flickering and non-flickering cool white fluorescent light to Culex quinquefasciatus (Diptera: Culicidae), Musca domestica (Diptera: Muscidae) and Pectinophora gossypiella (Lepidoptera: Gelechiidae) adults and Acheta domesticus (Orthoptera: Gryllidae) and Periplanata Americana (Blattodea: Blattidae) nymphs. Southwestern Entomologist 31: 77-81 (2006); Howard, R. W. and G. J. Blomquist. Chemical ecology and biochemistry of insect hydrocarbons. Annual Review of Entomology 27: 149-172 (1982); Lunau, K. Visual ecology of flies with particular reference to colour vision and colour preferences. Journal of Comparative Physiology A 200: 497-512 (2014); Stoffolano, J., E. Schauber, C. Yin, J. Tillman and G. Blomquist. Cuticular hydrocarbons and their role in copulatory behavior in Phormia regina (Meigen). Journal of Insect Physiology 43: 1065-1076 (1997); Wicker-Thomas, C. Pheromonal communication involved in courtship behaviour in Diptera. Journal of Insect Physiology 53: 1089-1100 (2007); Wilkinson, G. S. and P. M. Johns. Sexual selection and the evolution of mating systems in flies. pp. 312-339 (2005); D. K. Yeates and B. M. Weigmann (eds.). The biology of the Diptera. Columbia University Press, New York; Schultz, T. D., & Fincke, O. M. (2009). Structural colours create a flashing cue for sexual recognition and male quality in a Neotropical giant damselfly. Functional Ecology, 23(4), 724-732; Sweeney, A., Jiggins, C. and Johnsen, S. Polarized light as a butterfly mating signal. Nature 423, 31-32; White T E, Zeil J, Kemp D J (2015) Signal design and courtship presentation coincide for highly biased delivery of an iridescent butterfly mating signal. Evolution 69(1): 14-25 (2003); E. Shevtsova, C. Hansson, D. H. Janzen, and J. Kjaerandsen, “Stable structural color patterns displayed on transparent insect wings,” Proceedings of the National Academy of Sciences, vol. 108, no. 213, pp. 668-673 (2011); Lloyd, J. E., Notes on flash communication in the firefly *Pyractomena dispersa* (Coleoptera: Lampyridae). Ann. Entomol. Soc. Am. 57, 260-261. (1964); Lloyd, J. E., Bioluminescent communication in insects. Annu. Rev. Entomol. 16, 97-122 (1971).

Hereinafter, general aspects of implementation of the systems and methods of the disclosed embodiments will be described.

The system, or portions of the system, used in the embodiments described herein can be in the form of a “processing machine,” such as a general purpose computer, for example. As used herein, the term “processing machine” is to be understood to include at least one processor that uses at least one memory. The at least one memory stores a set of instructions. The instructions can be either permanently or temporarily stored in the memory or memories of the processing machine. The processor can execute the instructions that are stored in the memory or memories in order to process data. The set of instructions can include various instructions that perform a particular task or tasks, such as those tasks described above. Such a set of instructions for performing a particular task can be characterized as a program, software program, or simply software.

In certain embodiments, the processing machine can be a specialized processor.

As noted above, the processing machine can execute the instructions that are stored in the memory or memories to process data. This processing of data can be in response to commands by a user or users of the processing machine, in response to previous processing, in response to a request by another processing machine and/or any other input, for example.

It will be readily understood by those persons skilled in the art that the present invention is susceptible to broad utility and application. Many embodiments and adaptations of the present invention other than those herein described, as well as many variations, modifications and equivalent arrangements, will be apparent from, or reasonably suggested by, the present invention and foregoing description thereof, without departing from the substance or scope of the invention.

Examples of systems and methods for attracting insects by simulating wing flash are described below:

In one embodiment, a method for attracting insects by simulating wing flash can include (1) determining a light-pulse frequency that mimics a wing flash for a target winged insect species; and (2) controlling a light source to emit light at the light-pulse frequency.

In one embodiment, a wavelength composition of the emitted light can mimic the wing flash for a target winged insect species.

In one embodiment, the step of determining a light-pulse frequency that mimics a wing flash for a target winged insect species can include projecting light on a member of the target winged insect species; monitoring a frequency at which the light is reflected from the member's wings; and setting the light-pulse frequency to the monitored frequency.

In one embodiment, the method can further include adjusting at least one of the light-pulse frequencies, a light intensity, a wavelength composition, and a duty cycle based on a time of day.

In one embodiment, the method can further include adjusting at least one of the light-pulse frequencies, a light intensity, a wavelength composition, and a duty cycle based on the season.

In one embodiment, the method can further include adjusting at least one of the light-pulse frequencies, a light intensity, a wavelength composition, and a duty cycle based on the weather.

In one embodiment, the method can further include adjusting at least one of the light-pulse frequencies, a light intensity, a wavelength composition, and a duty cycle based on a geographical location.

In one embodiment, the member of the target insect species can be a sexually mature female.

In one embodiment, the light-pulse frequency can be between 1 and 10 pulses per second. In one embodiment, the light-pulse frequency can be between 50 and 500 pulses per second. In another embodiment, the light-pulse frequency can be between 185 and 195 pulses per second. In another embodiment, the light-pulse frequency can be between 395 and 405 pulses per second. In one embodiment, the light-pulse frequency can be between 400 and 1,000 pulses per second.

In one embodiment, the target insect species can be in the order Diptera. In another embodiment, the target insect species can be in the family Calliphoridae, Muscidae, Stratiomyidae, Drosophilidae, or Culicidae.

In one embodiment, the step of determining a light-pulse frequency that mimics a wing flash for a target insect species can include projecting light at a first light-pulse frequency in a first portion of an area comprising a plurality of members of the target species; monitoring a first reaction of the plurality of members of the target species in response to the light projected at the first light-pulse frequency; projecting light at a second light-pulse frequency in a second portion of the area comprising the plurality of members of the target species; monitoring a second reaction of the plurality of members of the target species in response to the light projected at the second light-pulse frequency; setting the light-pulse frequency to the first light-pulse frequency in response to the first reaction being larger than the second reaction; and setting the light-pulse frequency to the second light-pulse frequency in response to the second reaction being larger than the first reaction.

In one embodiment, light is projected at the first light-pulse frequency and the second light-pulse frequency at substantially the same time.

In one embodiment, the first portion of the area and the second portion of the area are the same portion of the area.

In one embodiment, the method can further include providing a trap to capture insects that respond to the light.

In one embodiment, the method can further include providing a lethal composition proximal to the light. The lethal composition can include at least one chemical.

In one embodiment, the method can further include providing a lethal physical agent proximal to the light. The lethal physical agent can be electricity.

Devices for attracting insects by simulating wing flash are disclosed. In one embodiment, a device can include a light source, a power source, and a controller that controls the operation of the light source. The light source can emit light at a light-pulse frequency that mimics a wing flash for a target insect species.

In one embodiment, a wavelength composition of the emitted light can mimic the wing flash for a target insect species.

In one embodiment, the mimicked wing flash can be that of a sexually mature female.

In one embodiment, the light-pulse frequency can be between 1 and 10 pulses per second. In one embodiment, the light-pulse frequency can be between 50 and 500 pulses per second. In another embodiment, the light-pulse frequency can be between 185 and 195 pulses per second. In another embodiment, the light-pulse frequency can be between 395 and 405 pulses per second. In one embodiment, the light-pulse frequency can be between 400 and 1,000 pulses per second.

In one embodiment, the target insect species can be in the order Diptera. In another embodiment, the target insect species can be in the family Calliphoridae, Muscidae, Stratiomyidae, Drosophilidae, or Culicidae.

In one embodiment, the device can further include a trap to capture insects that respond to the emitted light.

In one embodiment, the device can further include a lethal composition. The lethal composition can include at least one chemical.

In one embodiment, the device can further include a lethal physical agent proximal to the light source. The lethal physical agent can be electricity.

In one embodiment, the light source is a LED.

In one embodiment, the device can further include a second light source. The second light source can emit light at a second light-pulse frequency that mimics a wing flash for a second target insect species.

In one embodiment, the device can further comprise a photosensor. The light intensity can be adjusted based on an amount of ambient light sensed by the photosensor.

According to another embodiment, a method for attracting insects by simulating wing flash can include controlling a light source to emit light at a light-pulse frequency that mimics a wing flash for a target insect species.

In one embodiment, a wavelength composition of the emitted light can mimic the wing flash for a target insect species.

In one embodiment, the method can further include adjusting at least one of the light-pulse frequencies, a light intensity, a wavelength composition, and a duty cycle based on a time of day.

In one embodiment, the method can further include adjusting at least one of the light-pulse frequencies, a light intensity, a wavelength composition, and a duty cycle based on the season.

In one embodiment, the method can further include adjusting at least one of the light-pulse frequencies, a light intensity, a wavelength composition, and a duty cycle based on the weather.

In one embodiment, the method can further include adjusting at least one of the light-pulse frequencies, a light intensity, a wavelength composition, and a duty cycle based on a geographical location.

In one embodiment, the light-pulse frequency can mimic a wing flash for a sexually mature female of the target insect species.

In one embodiment, the light-pulse frequency can be between 1 and 10 pulses per second. In one embodiment, the light-pulse frequency can be between 50 and 500 pulses per second. In another embodiment, the light-pulse frequency can be between 185 and 195 pulses per second. In another embodiment, the light-pulse frequency can be between 395 and 405 pulses per second. In one embodiment, the light-pulse frequency can be between 400 and 1,000 pulses per second.

In one embodiment, methods of using pulsed light that mimics the frequency of light flashes reflected off the wings of a flying insect as an attractive stimulus for other insects are disclosed. In one embodiment, the flying insect is a female insect.

In one embodiment, the flying insect and the responding insect can be in the same species.

In one embodiment, the flying insect and the responding insect are in the order Diptera.

In another embodiment, the flying insect and the responding insect can be in the family Calliphoridae Muscidae, Stratiomyidae, Drosophilidae, or Culicidae.

In one embodiment, the frequency of the pulsed light can vary between one pulse per second and 1,000 pulses per second. In one embodiment, the frequency of the pulsed light can vary between one pulse and 600 pulses per second. For example, in one embodiment, for a specific species, a frequency of about 190 pulses per second is produced. In another embodiment, for a specific species, a frequency of about 665 pules per second is produced.

Pulsed light-emitting devices are disclosed. The emitted pulsed light can mimic the frequency of light flashes reflected off the wings of a flying insect and can act as an attractive stimulus for other insects.

In one embodiment, the pulsed light can mimic the frequency of wing flashes reflected off the wings of a flying female insect.

In one embodiment, the wing flash reflecting flying insect and the responding insect can be in the same species.

In one embodiment, the flying insect and the responding insect can be in the order Diptera.

In another embodiment, the flying insect and the responding insect can be in the family Calliphoridae, Muscidae, Stratiomyidae, Drosophilidae, or Culicidae.

In one embodiment, the light can be pulsed from a Light Emitting Diode (“LED”).

In one embodiment, the pulsed light can attract responding insects into a trap.

Methods of using pulsed light that mimics the frequency of light flashes reflected off the wings of a flying insect to attract other insects to a source of a lethal composition are disclosed. In one embodiment, the lethal composition can comprise one or more chemicals. In another embodiment, the lethal composition can comprise a pathogen.

In another embodiment, a physical retention mechanism (e.g., adhesives, traps, etc.) can be provided.

Methods of using pulsed light that mimics the frequency of light flashes reflected off the wings of a flying insect to attract other insects to a source of a lethal physical agent are disclosed. In one embodiment, the lethal physical agent can be electricity.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of ordinary skill in the art. Rather it is hereby intended the scope be defined by the claims appended various embodiments. The scope is, of course, not limited to the examples or embodiments set forth herein, but can be employed in any number of applications and equivalent articles by those of hereto.

1. A device for attracting insects by simulating wing flash comprising:
a light source; and
wherein the light source emits light at a light-pulse frequency that mimics a wing flash for a target winged insect species.

2. The device according to claim 1, wherein a wavelength of the emitted light mimics the wavelength of the wing flash for the target winged insect species.

3. The device according to claim 1, wherein the light-pulse frequency is between about 1 pulse per second and about 225 pulses per second.

4. The device according to claim 1, wherein the light-pulse frequency is between about 400 pulses per second and about 700 pulses per second.

5. The device according to claim 1, wherein the target winged insect species is in the order Diptera.

6. The device according to claim 1, wherein the target winged insect species is in the family Calliphoridae, Muscidae, Stratiomyidae, Drosophilidae, or Culicidae.

7. The device according to claim 1, further comprising:
a trap to capture insects that respond to the light.

8. The device according to claim 1, further comprising:
a lethal composition.

9. The device according to claim 1, wherein the light source comprises one or more light emitting diodes (“LEDs”).

10. The device according to claim 1, wherein the light source comprises a plurality of lights arranged to emulate a swarm of insects.

11. The device according to claim 1, wherein the light source is configured to move between one or more positions.

12. The device according to claim 1, further comprising:
a photosensor;
wherein a light intensity is adjusted based on an amount of ambient light sensed by the photosensor.

13. A method for attracting insects by simulating wing flash, the method comprising:
controlling a light source to emit light at a light-pulse frequency that mimics a wing flash for a target winged insect species.

14. The method according to claim 13 further comprising:
adjusting one or more of the light-pulse frequency, a light intensity, a wavelength composition, a duty cycle, and the position of the light source based on one or more of the target winged insect species, time of day, season, weather, and geographical location.

15. The method according to claim 13, wherein the light-pulse frequency mimics a wing flash for a sexually mature female of the target winged insect species.

16. The method according to claim 13, wherein the light-pulse frequency is between about 1 pulse per second and about 1,000 pulses per second.

17. The method according to claim 13, wherein the target winged insect species is in the order Diptera.

18. A method for attracting insects by simulating wing flash, comprising:
determining a light-pulse frequency that mimics a wing flash for a target winged insect species; and
controlling a light source to emit light at the light-pulse frequency.

19. The method according to claim 18, wherein the step of determining a light-pulse frequency that mimics a wing flash for a target winged insect species comprises:
projecting light on a member of the target winged insect species;
monitoring a frequency at which the light is reflected from the member's wings; and
setting the light-pulse frequency to the monitored frequency.

20. The method according to claim 18, wherein the step of determining a light-pulse frequency that mimics a wing flash for a target winged insect species comprises:
projecting light at a first light-pulse frequency in a first portion of an area comprising a plurality of members of the target winged insect species;
monitoring a first reaction of the plurality of members of the target winged insect species in response to the light projected at the first light-pulse frequency;
projecting light at a second light-pulse frequency in a second portion of the area comprising the plurality of members of the target winged insect species;
monitoring a second reaction of the plurality of members of the target winged insect species in response to the light projected at the second light-pulse frequency;
setting the light-pulse frequency to the first light-pulse frequency in response to the first reaction being larger than the second reaction; and
setting the light-pulse frequency to the second light-pulse frequency in response to the second reaction being larger than the first reaction.
